(19) United States
(12) Patent Application Publication
(10) Pub. No.: US 2005/0071843 A1
(43) Pub. Date: Mar. 31, 2005

(54) Topology aware scheduling for a multiprocessor system

(76) Inventors: Hong Guo, Scarborough (CA); Christopher Andrew Norman Smith, San Francisco, CA (US); Lionel Ian Lumb, Aurora (CA); Ming Wah Lee, Mississauga (CA); William Stevenson McMillan, Hampshire (GB)

Correspondence Address: Finnegan, Henderson, Farabow,;Garrett & Dunner, L.L.P., 1300 I Street, N.W., Washington, DC, 20005-3315, US

(21) Appl. No.: 10/053,740

(22) Filed: Jan. 24, 2002

(30) Foreign Application Priority Data
Dec. 20, 2001 (CA) 2,365,729

(51) Int. Cl. G06F 9/46

(52) U.S. Cl. 718/101; 718/104

(57) ABSTRACT

A system and method for scheduling jobs in a multiprocessor machine is disclosed. The status of CPUs on node boards in the multiprocessor machine is periodically determined. The status can indicate the number of CPUs available, and the maximum radius of free CPUs available to execute jobs. Memory allocation is also monitored. This information is provided to a scheduler that compares the status of the resources available against the resource requirements of jobs. The node boards and CPUS, as well as other resources such as memory, are arranged in hosts. The scheduler then schedules jobs to hosts that indicate they have resources available to execute the jobs. If none of the hosts indicate they have resources available to execute the jobs, the scheduler will wait until the resources become available. A best fit of job to resources is attained by scheduling jobs to hosts that have the maximum number of free CPUs for a radius corresponding to the CPU radius requirement of a job. Once the job is scheduled to a host, it is dispatched to a host and resources required to execute the job are allocated to the job at the host.

### FIELD OF THE INVENTION

The present invention relates to a multiprocessor system. More particularly, the present invention relates to a method, system and computer program product for scheduling jobs in a multiprocessor machine, such as a multiprocessor machine, utilizing a non-uniform memory access (NUMA) architecture.

### BACKGROUND OF THE INVENTION

Multiprocessor systems have been developed in the past in order to increase processing power. Multiprocessor systems comprise a number of central processing units (CPUs) working generally in parallel on portions of an overall task. A particular type of multiprocessor system used in the past has been a symmetric multiprocessor (SMP) system. An SMP system generally has a plurality of processors, with each processor having equal access to shared memory and input/output (I/O) devices shared by the processors. An SMP system can execute jobs quickly by allocating to different processors parts of a particular job.

To further increase processing power, processing machines have been constructed comprising a plurality of SMP nodes. Each SMP node includes one or more processors and a shared memory. Accordingly, each SMP node is similar to a separate SMP system. In fact, each SMP node need not reside in the same host, but rather could reside in separate hosts.

In the past, SMP nodes have been interconnected in some topology to form a machine having non-uniform memory access (NUMA) architecture. A NUMA machine is essentially a plurality of interconnected SMP nodes located on one or more hosts, thereby forming a cluster of node boards.

Generally, the SMP nodes are interconnected and cache coherent so that the memory in an SMP node can be accessed by a processor on any other SMP node. However, while a processor can access the shared memory on the same SMP node uniformly, meaning within the same amount of time, processors on different boards cannot access memory on other boards uniformly. Accordingly, an inherent characteristic of NUMA machines and architecture is that not all of the processors can access the same memory in a uniform manner. In other words, while each processor in a NUMA system may access the shared memory in any SMP node in the machine, this access is not uniform.

This non-uniform access results in a disadvantage in NUMA systems in that a latency is introduced each time a processor accesses shared memory, depending on the combination of CPUs and nodes upon which a job is scheduled to run. In particular, it is possible for program pages to reside “far” from the processing data, resulting in a decrease in the efficiency of the system by increasing the latency time required to obtain this data. Furthermore, this latency is unpredictable because is depends on the location where the shared memory segments for a particular program may reside in relation to the CPUs executing the program. This affects performance prediction, which is an important aspect of parallel programming. Therefore, without knowledge of the topology, performance problems can be encountered in NUMA machines.

Prior art devices have attempted to overcome these deficiencies inherent in NUMA systems in a number of ways. For instance, programming tools to optimize program page and data processing have been provided. These programming tools for programmers assist a programmer to analyze their program dependencies and employ optimization algorithms to optimize page placement, such as making memory and processing mapping requests to specific nodes or groups of nodes containing specific processors and shared memory within a machine. While these prior art tools can be used by a single programmer to optimally run jobs in a NUMA machine, these tools do not service multiple programmers well. Rather, multiple programmers competing for their share of machine resources may conflict with the optimal job placement and optimal utilization of other programmers using the same NUMA host or cluster of hosts.

To address this potential conflict between multiple programmers, prior art systems have provided resource management software to manage user access to the memory and CPUs of the system. For instance, some systems allow programmers to “reserve” CPUs and shared memory within a NUMA machine. One such prior art system is the Miser™ batch queuing system that chooses a time slot when specific resource requirements, such as CPU and memory, are available to run a job. However, these batch queuing systems suffer from the disadvantage that they generally cannot be changed automatically to re-balance the system between interactive and batch environments. Also, these batch queuing systems do not address job topology requirements that can have a measurable impact on the job performance.

Another manner to address this conflict has been to use groups of node boards, which are occasionally referred to as “CPUsets” or “processor sets”. Processor sets specify CPU and memory sets for specific processes and have the advantage that they can be created dynamically out of available machine resources. However, processor sets suffer from the disadvantage that they do not implement any resource allocation policy to improve efficient utilization of resources. In other words, processor sets are generally configured on an ad-hoc basis, without recourse to any policy based scheduling or enforcement of job topology.

A further disadvantage common to all prior art resource management software for NUMA machines is that they do not consider the transient state of the NUMA machine. In other words, none of the prior art systems consider how a job being executed by one SMP node or a cluster of SMP nodes in a NUMA machine will affect execution of a new job.

Accordingly, there is a need in the art for a scheduling system which can dynamically schedule and allocate jobs to resources, but which is nevertheless governed by a policy to improve efficient allocation of resources. Also, there is a need in the art for a system and method that is not restricted to a single programmer, but rather can be implemented by multiple programmers competing for the same resources. Furthermore, there is a need in the art for a method and system to schedule and dispatch jobs based on the transient topology of the NUMA machine, rather than on the basis that each CPU in a NUMA machine is homogenous. Furthermore, there is a need in the art for a method, system and computer program product which can dynamically monitor the topology of a NUMA machine and schedule and dispatch jobs in view of transient changes in the topology of the system.

### SUMMARY OF THE INVENTION

Accordingly, it is an object of this invention to at least partially overcome the disadvantages of the prior art. Also, it is an object of this invention to provide an improved type of method, system and computer program product that can more efficiently schedule and allocate jobs in a NUMA machine.

Accordingly, in one of its aspects, this invention resides in a computer system comprising a cluster of node boards, each node board having at least one central processor unit (CPU) and shared memory, said node boards being interconnected into groups of node boards providing access between the central processing units (CPUs) and shared memory on different node boards, a scheduling system to schedule a job to said node boards which have resources to execute the jobs, said batch scheduling system comprising a topology monitoring unit for monitoring a status of the CPUs and generating status information signals indicative of the status of each group of node boards; a job scheduling unit for receiving said status information signals and said jobs, and, scheduling the job to one group of node boards on the basis of which group of node boards have the resources required to execute the job as indicated by the status information signals.

In another aspect, the present invention resides in a a computer system comprising resources physically located in more than one module, said resources including a plurality of processors being interconnected by a number of interconnections in a physical topology providing non-uniform access to other resources of said computer system, a method of scheduling a job to said resources, said method comprising the steps of:
(a) periodically assessing a status of the resources and sending status information signals indicative of the status of the resources to a job scheduling unit;
(b) assessing, at the job scheduling unit, the resources required to execute a job;
(c) comparing, at the job scheduling unit, the resources required to execute the job and resources available based on the status information signals; and
(d) scheduling the job to the resources which are available to execute the job as based on the status information signals and the physical topology, and the resources required to execute the job.

Accordingly, one advantage of the present invention is that the scheduling system comprises a topology monitoring unit which is aware of the physical topology of the machine comprising the CPUs, and monitors the status of the CPUs in the computer system. In this way, the topology monitoring unit provides current topological information on the CPUs and node boards in the machine, which information can be sent to the scheduler in order to schedule the jobs to the CPUs on the node boards in the machine. A further advantage of the present invention is that the job scheduler can make a decision as to which group of processor or node boards to send a job based on the current topological information of all of the CPUs. This provides a single decision point for allocating the jobs in a NUMA machine based on the most current and transcient status information gathered by the topology monitoring unit for all of the node boards in the machine. This is particularly advantageous where the batch job scheduler is allocating jobs to a number of host machines, and the topology monitoring unit is monitoring the status of the CPUs in all of the hosts.

In one embodiment, the status information provided by the topology unit is indicative of the number of free CPUs for each radius, such as 0, 1, 2, 3 . . . N. This information can be of assistance to the job scheduler when allocating jobs to the CPUs to ensure that the requirements of the jobs can be satisfied by the available resources, as indicated by the topology monitoring unit. For larger systems, rather than considering radius, the distance between the processor may be calculated in terms of delay, reflecting that the time delay of various interconnections may not be the same.

A still further advantage of the invention is that the efficiency of the overall NUMA machine can be maximized by allocating the job to the “best” host or module. For instance, in one embodiment, the “best” host or module is selected based on which of the hosts has the maximum number of available CPUs of a particular radius available to execute a job, and the job requires CPUs having that particular radius. For instance, if a particular job is known by the job scheduler to require eight CPUs within a radius of two, and a first host has 16 CPUs available at a radius of two but a second host has 32 CPUs available at a radius of two, the job scheduler will schedule the job to the second host. This balances the load of various jobs amongst the host. This also reserves a number of CPUs with a particular radius available for additional jobs on different hosts in order to ensure resources are available in the future, and, that the load of various jobs will be balanced amongst all of the resources. This also assists the topology monitoring unit in allocating the resources to the job because more than enough resources should be available.

In a further embodiment of the present invention, the batch scheduling system provides a job execution unit associated with each execution host. The job execution unit allocates the jobs to the CPUs in a particular host for parallel execution. Preferably, the job execution unit communicates with the topology monitoring unit in order to assist in advising the topology monitoring unit of the status of various node boards within the host. The job execution unit can then advise the job topology monitoring unit when a job has been allocated to a group of nodes. In a preferred embodiment, the topology monitoring unit can allocate resources, such as by allocating jobs to groups of CPUs based on which CPUs are available to execute the jobs and have the required resources such as memory.

A further advantage of the present invention is that the job scheduling unit can be implemented as two separate schedulers, namely a standard scheduler and an external scheduler. The standard scheduler can be similar to a conventional scheduler that is operating on an existing machine to allocate the jobs. The external scheduler could be a separate portion of the batch job scheduler which receives the status information signals from the topology monitoring unit. In this way, the separate external scheduler can keep the specifics of the status information signals apart from the main scheduling loop operated by the standard scheduler, avoiding a decrease in the efficiency of the standard scheduler. Furthermore, having the external scheduler separate from the standard scheduler provides more robust and efficient retrofitting of existing schedulers with the present invention. In addition, as new topologies or memory architectures are developed in the future, having a separate external scheduler assists in upgrading the job scheduler because only the external scheduler need be upgraded or patched.

A further advantage of the present invention is that, in one embodiment, jobs can be submitted with a topology requirement set by the user. In this way, at job submission time, the user, generally one of the programmers sending jobs to the NUMA machine, can define the topology requirement for a particular job by using an optional command in the job submission. This can assist the batch job scheduler in identifying the resource requirements for a particular job and then matching those resource requirements to the available node boards, as indicated by the status information signals received from the topology monitoring unit. Further, any one of multiple programmers can use this optional command and it is not restricted to a single programmer.

Further aspects of the invention will become apparent upon reading the following detailed description and drawings which illustrate the invention and preferred embodiments of the invention.

### BRIEF DESCRIPTION OF THE DRAWINGS

In the drawings, which illustrate embodiments of the invention:

FIGS. 1A and 1B are a schematic representation and a configuration representation, respectively, of a symmetric multiprocessor having non-uniform memory access architecture and having eight node boards in a rack system;

FIGS. 2A and 2B are a schematic representation and a configuration representation, respectively, of a symmetric multiprocessor having non-uniform memory access architecture and having 16 node boards in a multirack system; and

FIGS. 3A and 3B are a schematic representation and a configuration representation, respectively, of a symmetric multiprocessor having non-uniform memory access architecture and having 32 node boards in a multirack system;

FIG. 4 is an enlarged configuration representation of a symmetric multiprocessor having 64 node boards in a multirack system, including a cray router for routing the jobs to the processors on the node boards;

FIG. 5 is a schematic representation of a multiprocessor having 64 processors arranged in a fat tree structure;

FIG. 6 is a symbolic representation of a job submission through a scheduler according to one embodiment of the present invention; and

FIG. 7 is a schematic representation of two node boards.

FIG. 8a is a schematic representation of the physical topology of a symmetrical multiprocessor having 8 node boards in a rack system, similar to FIG. 1a, and, FIGS. 8b and 8c are schematic representations of the transient or virtual topology shown in FIG. 8a, representing that some of the node boards have processors which are unavailable for executing new jobs.

FIG. 9a is a schematic representation of the physical topology of a symmetrical multiprocessor having 16 node boards in a rack system, similar to FIG. 2a, and FIGS. 9b to 9g are schematic representations of the transient or virtual topology shown in FIG. 9a, representing that some of the node boards have processors which are unavailable for executing new jobs.

FIG. 10 is a symbolic representation of a system having a META router connecting n hosts or modules.

### DETAILED DESCRIPTION OF THE PREFERRED EMBODIMENTS

Preferred embodiments of the present invention and its advantages can be understood by referring to the present drawings. In the present drawings, like numerals are used for like and corresponding parts of the accompanying drawings.

FIG. 1A shows a schematic representation of a symmetric multiprocessor of a particular type of topology, shown generally by reference numeral 8, and having non-uniform memory access architecture. The symmetric multiprocessor topology 8 shown in FIG. 1A has eight node boards 10. The eight node boards 10 are arranged in a rack system and are interconnected by the interconnection 20, also shown by letter “R”. FIG. 1A shows a configuration representation, shown generally by reference numeral 8c, of the multiprocessor topology 8 shown schematically in FIG. 1A. As is apparent from FIG. 1B, the configuration representation 8c shows all of the eight boards 10 in a single host or module 40. In this context, the terms host and module will be used interchangeably because actual physical configuration of the multiprocessor, and the terms used to describe the physical configuration, may differ between different hardware manufacturers.

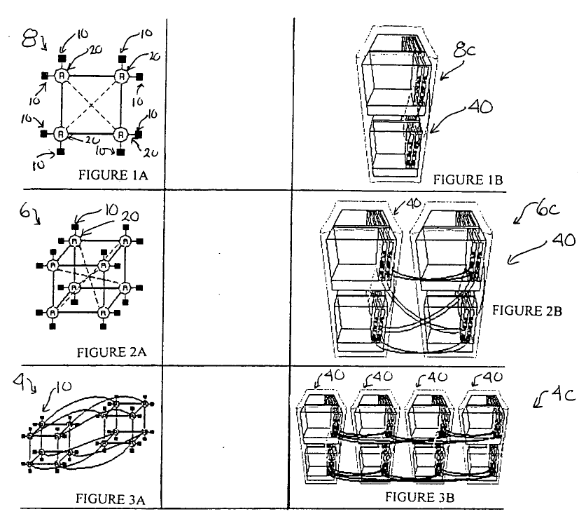

The symmetric multiprocessor topology 8 shown in FIG. 1A can be expanded to have additional node boards. For instance, FIG. 2A shows a schematic representation of a symmetric multiprocessor topology, shown generally by reference numeral 6, having 16 node boards 10 arranged in a cube design. As with the eight board multiprocessor topology 8, the node boards 10 of multiprocessor topology 6 are interconnected by interconnections, shown by reference numeral 20 and also the letter R.

FIG. 2B illustrates a configuration representation, shown generally by reference numeral 6c, of the 16 board microprocessor topology 6, shown schematically in FIG. 2A. As shown in FIG. 2B, in one embodiment the 16 node boards 10 are physically configured on two separate hosts or modules 40.

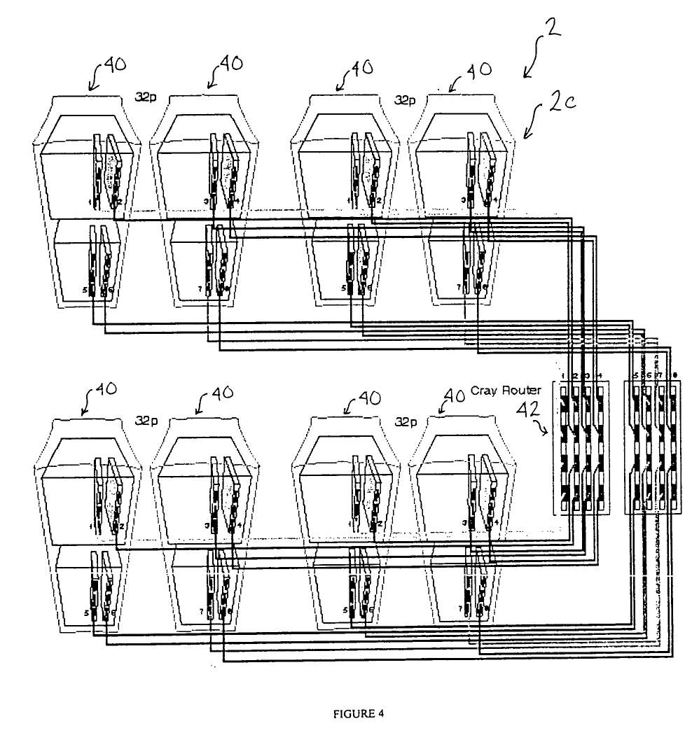

Likewise, FIG. 3A shows a schematic representation of a 32 node board multiprocessor topology, shown generally by reference numeral 4, and sometimes referred to as a bristled hypercube. As shown in FIG. 3B, the 32 board topology has boards physically located on four separate hosts 40.

FIG. 4 illustrates a configuration representation of a 64 board symmetric multiprocessor topology, shown generally by reference numeral 2, and sometimes referred to as a heirarchical fat bristled hypercube. The topology 2 shown in FIG. 4 combines two 32 board multiprocessor topologies 4 as shown in FIGS. 3A and 3B. The 64 board topology 2 shown in FIG. 4 essentially uses a cray router 42 to switch data between the various hosts 40 in the topology 2. Because the cray router 42 generally requires much more time to switch information than an interconnection 20, shown by letter “R”, it is clear that in the 64 board topology 2 efficiency can be increased if data transfer between hosts 40 is minimized.

It is understood that each of the node boards 10 will have at least one central processing unit (CPU), and some shared memory. In the embodiment where the node boards 10 contain two processors, the eight node boards 10 shown in the eight board symmetric multiprocessor topology 8 in FIG. 1A will contain up to 16 processors. In a similar manner, the symmetric multiprocessor topology 6 in FIG. 2A can contain up to 32 processors on 16 node boards 10, and, the symmetric multiprocessor topology 4 shown in FIG. 3A can contain up to 64 processors on 32 node boards 10. It is understood that the node boards 10 could contain additional CPUs, in which case the total number of processors in each of the symmetric multiprocessor topologies 8, 6 and 4, could be more.

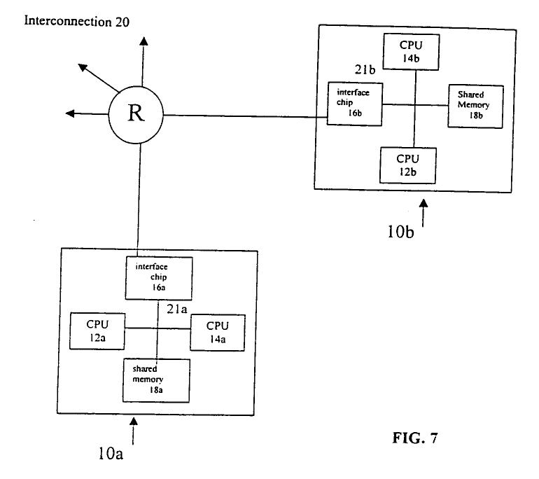

FIG. 7 shows a schematic representation of two node boards 10a, 10b and an interconnection 20 as may be used in the symmetric multiprocessor topologies 4, 6 and 8 shown in FIGS. 1A, 2A and 3A. As shown in FIG. 7, the two node boards 10a, 10b are connected to each other through the interconnection 20. The interconnection 20 also connects the node boards 10a, 10b to other node boards 10, as shown by the topologies illustrated in FIGS. 1A, 2A and 3A.

Node board 10a contains, in this embodiment, two CPUs 12a and 14a. It is understood that additional CPUs could be present. The node board 10a also contains a shared memory 18a which is present on the node board 10a. Node bus 21a connects CPUs 12a, 14a to shared memory 18a. Node bus 21a also connects the CPUs 12a, 14a and shared memory 18a through the interconnection 20 to the other node boards 10, including node board 10b. In a preferred embodiment, an interface chip 16a may be present to assist in transferring information between the CPUs 12a, 14a and the shared memory 18 on node board 10a as well as interfacing with input/output and network interfaces (not shown). In a similar manner node board 10b, includes CPUs 12b, 14b interconnected by node bus 21b to shared memory 18b and interconnection 20 through interface chip 16b. Accordingly, each node board 10 would be similar to node boards 10a, 10b in that each node board 10 would have at least one CPU 12 and/or 14, shared memory 18 on the node board 10, and an interconnection 20 permitting access to the shared memory 18 and CPUs 12, 14 on different node boards 10.

It is apparent that the processors 12a, 14a on node board 10a have uniform access to the shared memory 18a on node board 10a. Likewise, processors 12b, 14b on node board 10b have uniform access to shared memory 18b. While processors 12b, 14b on node board 10b have access to the shared memory 18a on node board 10a, processors 12b, 14b can only do so by accessing the interconnection 20, and if present, interface chip 16a and 16b.

It is clear that the CPUs 12, 14 accessing shared memory 18 on their local node board 10 can do so very easily by simply accessing the node bus 21. This is often referred to as a local memory access and the processors, 12a, 14a on the same node board 10a are considered to have a radius of zero because they can both access the memory 18 without encountering an interconnection 20. When a CPU 12, 14 accesses memory 18 on another node board 10, that access must be made through at least one interconnection 20. Accordingly, it is clear that remote memory access is not equivalent to or uniform with local memory access. Futhermore, in the more complex 32 board topology 4 illustrated in FIG. 3A, more than one interconnection 20 may be encountered depending on which two node boards 10 are exchanging data. Thus, a variable latency time is encountered when CPUs 12, 14 access-shared memory 18 on different node boards 10 resulting in access between processors 12, 14 and shared memory 18 on different node boards 10 being non-uniform.

It is understood that the host or module 40 may have many processors 12, 14 located on a number of boards. In other words, while the physical configurations shown by reference numerals 8c, 6c, 4c and 2c illustrate selected boards 10 in the host 40, the host 40 may have a large number of other boards. For instance, the Silicon Graphics™ Origin Series of multiprocessors can accommodate up to 512 node boards 10, with each node board 10 having at least two processors and up to four gigabytes of shared memory 18. This type of machine allows programmers to run massively parallel programs with very large memory requirements using NUMA architecture.

Furthermore, in a preferred embodiment of the present invention, the different topologies 8, 6, 4 and 2 shown in FIGS. 1A to 4 can be used and changed dynamically. For instance, in the configuration 4c where the 32 board topology, shown by reference numeral 4, is used, it is possible for this topology to be separated, if the job requirements are such, so that two 16 board topologies 6 can be used rather than the 32 board topology, shown by reference numeral 6.

In other words, the node boards 10 can be arranged in different groups corresponding to the topologies 8, 6, 4 and 2. Jobs can be allocated to these different possible groups or topologies 8, 6, 4 and 2, depending on the job requirements. Furthermore, as illustrated by the configuration representations 8c, 6c, 4c and 2c, the groups of boards 10 can be located on separate hosts 40.

It is understood that the larger number of interconnections 20 required to communicate between node boards 10, the greater the latency required to transfer data. This is often referred to as the radius between the CPUs 12, 14 or the node boards 10. For a radius of “0”, no interconnections are encountered when transferring data between particular node boards 10. This occurs, for instance, when all the CPUs 12, 14 executing a job are located on a single node board 10. For a radius of 1, only one interconnection 20 is located between processors 12, 14 executing the job. For instance, in FIG. 7, the radius from node board 10a to node board 10b is 1 because one interconnection 20 is encountered when transferring data from node board 10a to node board 10b. For a radius of two, two interconnections 20 are encountered for transferring data between a first node board 10 and another node board 10.

FIGS. 1A to 4 illustrate the topologies 8, 6, 4 and 2, generally used by Silicon Graphics™ symmetric multiprocessor machines, such as the Origin Series. These topologies 8, 6, 4, 2 generally use a fully connected crossbar switch hyper-cube topology. It is understood that additional topologies can be used and different machines may have different topologies.

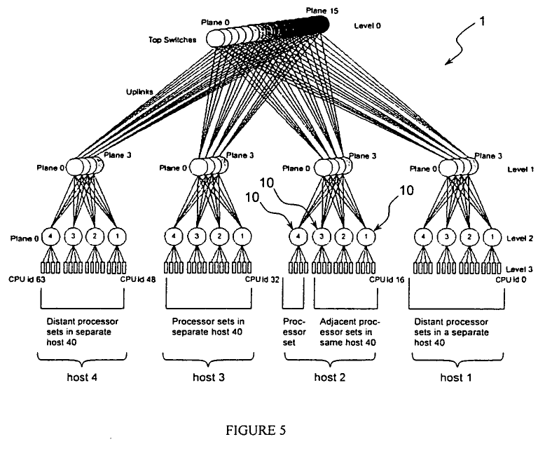

For instance, FIG. 5 shows the topology for a Compaq™ symmetric multiprocessing machine, shown generally by reference numeral 1, which topology is often referred to as a fat tree topology because it expands from a level 0. FIG. 5 is similar to the Silicon Graphics™ topologies 8, 6, 4 and 2 in that the Compaq™ topology 1 shows a number of processors, in this case 64 processors identified by CPU id 0 to CPU id 63 which are arranged in groups of node boards 10 referred to in the embodiment as processor sets. For instance, the processors identified by CPU id 31, 30, 29 and 28 form a group of node boards 10 shown as being part of processor set 4 at level 2 in host 2. The host 2 contains adjacent processor sets or groups of node boards 10. Instead of processors, the fat tree topology shown in FIG. 5 could also be used to as an interconnect architecture for a cluster of symmetrical multiprocessors.

As with the Silicon Graphics™ topologies 8, 6, 4 and 2, the Compaq™ topology 1 has non-uniform memory access in that the CPUs 31 to 28 will require additional time to access memory in the other processor sets because they must pass through the interconnections at levels 1 and 2. Furthermore, for groups of nodes or processor sets in separate hosts 40, which are the CPUs identified by CPU id 0 to 15, 32 to 47 and 48 to 63, an even greater latency will be encountered as data requests must travel through level 1 of host 2, level 0 which is the top switches, and then level 1 of one of the host machines 1, 3 or 4 and then through level 2 to a group of node boards 10.

It is understood that groups of node boards 10 have been used to refer to any combination of node boards 10, whether located in a particular host or module 40 or in a separate host or module 40. It is further understood that the group of node boards 10 can include “CPUsets” or “processor sets” which refer to sets of CPUs 12, 14 on node boards 10 and the associated resources, such as memory 18 on node board 10. In other words, the term “groups of node boards” as used herein is intended to include various arrangements of CPUs 12, 14 and memory 18, including “CPUsets” or “processor sets”.

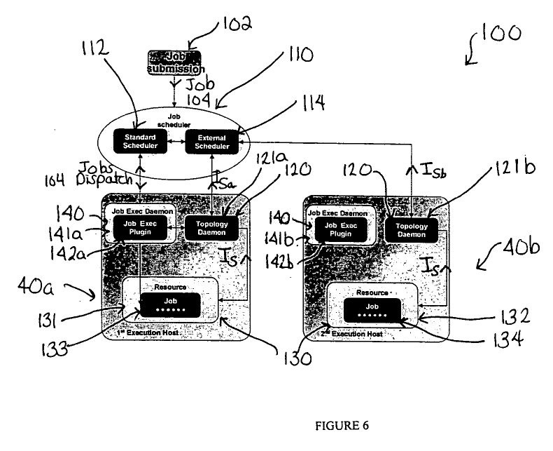

FIG. 6 illustrates a scheduling system, shown generally by reference 100, according to one embodiment of the present invention.

The job scheduling system 100 comprises a job scheduling unit, shown generally by reference numeral 110, a topology monitoring unit, shown generally by reference numeral 120 and a job execution unit, shown generally by reference numeral 140. The components of the job scheduling system 100 will now be described.

The job scheduling unit 110 receives job submissions 102 and then schedules the job submissions 102 to one of the plurality of execution hosts or modules 40. In the embodiment shown in FIG. 6, only two execution hosts 40a, 40b are shown, but it is understood that more execution hosts 40 will generally be present. Each execution host 40 will have groups of node boards 10 in topologies 8, 6, 4, 2, as described above, or other topologies (not shown). Accordingly, the combination of execution hosts 40 will form a cluster of node boards 10 having resources, shown generally by reference numeral 130, to execute the jobs 104 being submitted by the job submission 102. One of these resources 130 will be processors 12, 14 and the combination of execution hosts 40 will provide a plurality of processors 12, 14.

In a preferred embodiment, the job scheduling unit 110 comprises a standard scheduler 112 and an external scheduler 114. The standard scheduler 112 can be any type of scheduler, as is known in the art, for dispatching jobs 104. The external scheduler 114 is specifically adopted for communicating with the topology monitoring unit 120. In particular, the external scheduler 114 receives status information signals Is from the topology monitoring unit 120.

In operation, the standard scheduler 112 generally receives the jobs 104 and determines what resources 130 the jobs 104 require. In a preferred embodiment, the jobs 104 define the resource requirements, and preferably the topology requirements, to be executed. The standard scheduler 112 then queries the external scheduler 114 for resources 130 which are free and correspond to the resources 130 required by the jobs 104 being submitted.

In a preferred embodiment, as described more fully below, the job scheduler 110 may also determine the “best” fit to allocate the jobs 104 based on predetermined criteria. Accordingly, in one embodiment, the external scheduler 114 acts as a request broker by translating the user supplied resource and/or topology requirements associated with the jobs 104 to an availability query for the topology monitoring unit 120. The topology monitoring unit 120 then provides status information signals I_{S} indicative of the resources 130 which are available to execute the job 104. The status information signals Is reflect the virtual or transcient topology in that they consider the processors which are available at that moment and ignore the processors 12, 14 and other resources 120 which are executing other jobs 104. It is understood that either the information signals I_{S} can be provided periodically by the topology monitoring unit 120, or, the information signals Is can be provided in response to specific queries by the external scheduler 114.

It is understood that the job scheduler 110 can be integrally formed and perform the functions of both the standard scheduler 112 and the external scheduler 114. The job scheduler 110 may be separated into the external scheduler 114 and the standard scheduler 112 for ease of retrofitting existing units.

The topology monitoring unit 120 monitors the status of the resources 130 on each of the hosts 40, such as the current allocation of the hardware. The topology monitoring unit 120 provides a current transcient view of the hardware graph and in-use resources 130, which includes memory 18 and processors 12, 14.

In one embodiment, the topology monitoring unit 120 can determine the status of the processors 12, 14 by interogating a group of nodes 10, or, the processors, 12, 14 located on the group of nodes 18. The topology monitoring unit 120 can also perform this function by interrogating the operating system. In a further embodiment, the topology monitoring unit 120 can determine the status of the processors by tracking the jobs being scheduled to specific processors 12, 14 and the allocation and de-allocation of the jobs.

In a preferred embodiment, the topology monitoring unit 120 considers boot processor sets, as well as processor sets manually created by the system managers, and adjusts its notion of available resources 130, such as CPU availability, based on this information. In a preferred embodiment, the topology monitoring unit 120 also allocates and de-allocates the resources 130 to the specific jobs 104 once the jobs 104 have been dispatched to the hosts or modules 40.

In a preferred embodiment, the topology monitoring unit 120 comprises topology daemons, shown generally by reference numerals 121a, 121b, running on a corresponding host 40a and 40b, respectively. The topology daemons 121 perform many of the functions of the topology monitoring unit 120 described generally above, on the corresponding host. The topology daemons 121 also communicate with the external scheduler 114 and monitor the status of the resources 130. It is understood that each topology daemon 121a, 121b will determine the status of the resources 130 in its corresponding host 40a, 40b, and generate host or module status information signals I_{Sa}, I_{Sb} indicative of the status of the resources 130, such as the status of groups of node boards 10 in the hosts 40a, 40b.

The scheduling system 100 further comprises job execution units, shown generally by reference numeral 140, which comprise job execution daemons 141a, 141b, running on each host 40a, 40b. The job execution daemons 141 receive the jobs 104 being dispatched by the job scheduler unit 110. The job execution daemons 141 then perform functions for executing the jobs 104 on its host 40, such as a pre-execution function for implementing the allocation of resources, a job starter function for binding the job 104 to the allocated resources 130 and a post execution function where the resources are de-allocated.

In a preferred embodiment, the job execution daemons 141a, 141b comprise job execution plug-ins 142a, 142b, respectively. The job execution plug-ins 142 can be combined with the existing job execution daemons 141, thereby robustly retrofitting existing job execution daemons 141. Furthermore, the job execution plug-ins 142 can be updated or patched when the scheduling system 100 is updated. Accordingly, the job execution plug-ins 142 are separate plug-ins to the job execution daemons 141 and provide similar advantages by being separate plug-ins 143, as opposed to part of the job execution daemons 141.

The operation of the job scheduling system 100 will now be described with respect to a submission of a job 104.

Initially, the job 104 will be received by the job scheduler unit 110. The job scheduler unit 110 will then identify the resource requirements, such as the topology requirement, for the job 104. This can be done in a number of ways, as is known in the art. However, in a preferred embodiment, each job 104 will define the resource requirements for executing the job 104. This job requirement for the job 104 can then be read by the job scheduler unit 110.

An example of a resource requirement or topology requirement command in a job 104 could be as follows:
bsub-n 32-extsched
“CPU_LIST= . . . ;CPUSET_OPTIONS= . . . ” command
where:
CPU_LIST=24-39, 48-53
CPUSET_OPTIONS=CPUSET_CPUEXCLUSIVECPUSET_MEMORY_MANDATORY

This command indicates that the job 104 has an exclusive “CPUset” or “processor set” using CPUs 24 to 39 and 48 to 53. This command also restricts the memory allocation for the process to the memory on the node boards 10 in which these CPUs 24 to 39 and 48 to 53 reside. This type of command can be set by the programmer. It is also understood that multiple programmers can set similar commands without competing for the same resources. Accordingly, by this command, a job 104 can specify an exclusive set of node boards 10 having specific CPUs and the associated memory with the CPUs. It is understood that a number of the hosts or modules 40 may have CPUs that satisfy these requirements.

In order to schedule the request, the job scheduler unit 110 will then compare the resource requirements for the job 104 with the available resources 130 as determined by the status information signals Is received by the topology monitoring unit 120. In one embodiment, the topology monitoring unit 120 can periodically send status information signals I_{S} to the external scheduler 114. Alternatively, the external scheduler 110 will query the topology monitoring unit 120 to locate a host 40 having the required resource requirements. In the preferred embodiment where the topology monitoring unit 120 comprises topology daemons 121a, 121b running on the host 40, the topology daemons 121a, 121b generally respond to the queries from the external scheduler 114 by generating and sending module status information signals I_{Sa}, I_{Sb} indicative of the status of the resources 130, including the processors 12, 14, in each host. The status information signals I_{S} can be fairly simple, such as by indicating the number of available processors 12, 14 at each radius, or can be more complex, such as by indicating the specific processors which are available, along with the estimated time latency between the processors 12, 14 and the associated memory 18.

In the embodiment where the external scheduler 114 queries the topology daemons 121a, 121b on each of the hosts 40a, 40b, it is preferred that this query is performed with the normal scheduling run of the standard scheduler 112. This means that the external scheduler 114 can coexist with the standard scheduler 112 and not require extra time to perform this query.

After the scheduling run, the number of hosts 40 which can satisfy the resource requirements for the job 104 will be identified based in part on the status information signals I_{S}. The standard scheduler 112 schedules the job 104 to one of these hosts 40.

In a preferred embodiment, the external scheduler 114 provides a list of the hosts 40 ordered according to the “best” available resources 130. The best available resources 130 can be determined in a number of ways using predetermined criteria. In non-uniform memory architecture systems, because of the time latency as described above, the “best” available resources 130 can comprise the node boards 10 which offer the shortest radius between CPUs for the required radius of the job 104. In a further preferred embodiment, the best fit algorithm would determine the “best” available resources 130 by determining the host 40 with the largest number of CPUS free at a particular radius required by the topology requirements of the job 104. The predetermined criteria may also consider other factors, such as the availability of memory 18 associated with the processors 12, 14, availability of input/output resources and time period required to access remote memory.

In the event that no group of node boards 10 in any of the hosts 40 can satisfy the resource requirements of a job 104, the job 104 is not scheduled. This avoids a job 104 being poorly allocated and adversely affecting the efficiency of all of the hosts 40.

Once a determination is made of the best available topology of the available node boards 10, the job 104 is dispatched from the job scheduler unit 110 to the host 40 containing the best available topology of node boards 10. The job execution unit 140 will then ask the topology monitoring unit 120 to allocate a group of node boards 10, for the job 104. For instance, in FIG. 6, the scheduling unit 110 has dispatched the job 104 to the first execution host 40a because the module status information signals Is a would have indicated that the host 40a had resources 130 available which the external scheduler 114 determined were required and sufficient to execute the job 104. In this case, the job execution unit 140, and specifically in this embodiment the job execution daemon 141a, will receive the job 104. The job execution plug-in 142a on the first execution host 40a will query the topology monitoring unit 120, in this case the topology daemon 121a running on the first execution host 40a, for resources 130 corresponding to the resources 130 required to executed the job 104. The host 40a should have resources 130 available to execute the job 104, otherwise the external scheduler 114 would not have scheduled the job 104 to the first host 40a. The topology daemon 121 may then allocate resources 130 for execution of the job 104 by selecting a group of node boards 10 satisfying the requirements of the job 104. In a preferred embodiment, the topology daemon 121 will create a processor set based on the selected group of node boards 10 to prevent thread migration and allocate the job 104 to the processor set.

In a preferred embodiment, the topology daemon 121a will name the allocated CPUset using an identification unique to the job 104. In this way, the job 104 will be identified with the allocated processor set. The job execution plug-in 142a then performs a further function of binding the job 104 to the allocated processor set. Finally, once the job 104 has been executed and its processes exited to the proper input/output unit (not shown), the job execution plug-in 142a performs the final task of asking the topology daemon 121 to de-allocate the processors 12, 14 previously allocated for the job 104, thereby freeing those resources 130 for other jobs 104. In one embodiment, as discussed above, the topology monitoring unit 120 can monitor the allocation and de-allocation of the processors 12, 14 to determine the available or resources 130 in the host or module 40.

In a preferred embodiment, the external scheduler 114 can also act as a gateway to determine which jobs 104 should be processed next. The external scheduler 114 can also be modified to call upon other job schedulers 110 scheduling jobs 104 to other hosts 40 to more evenly balance the load.

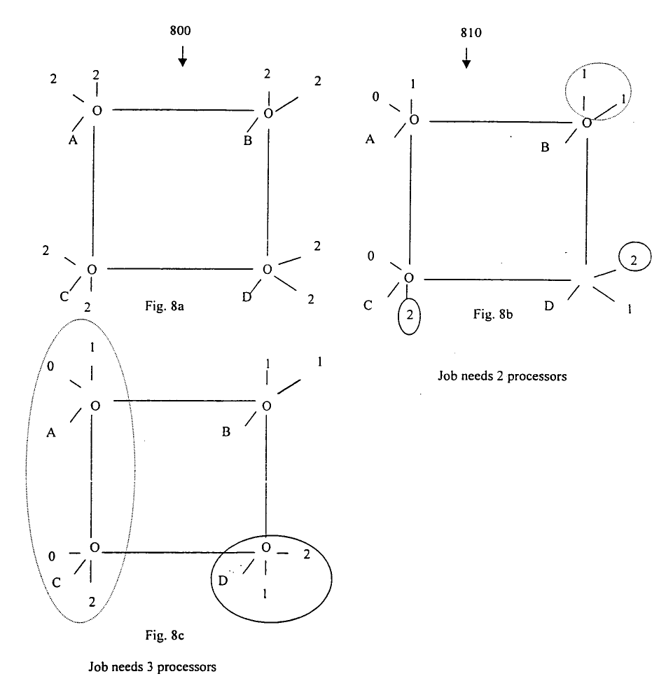

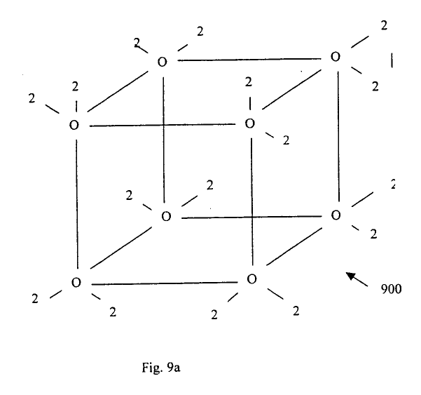

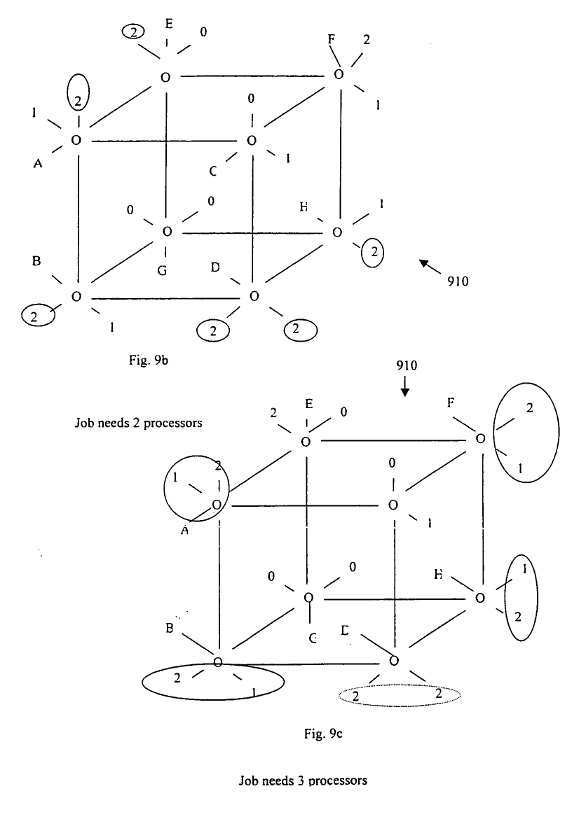

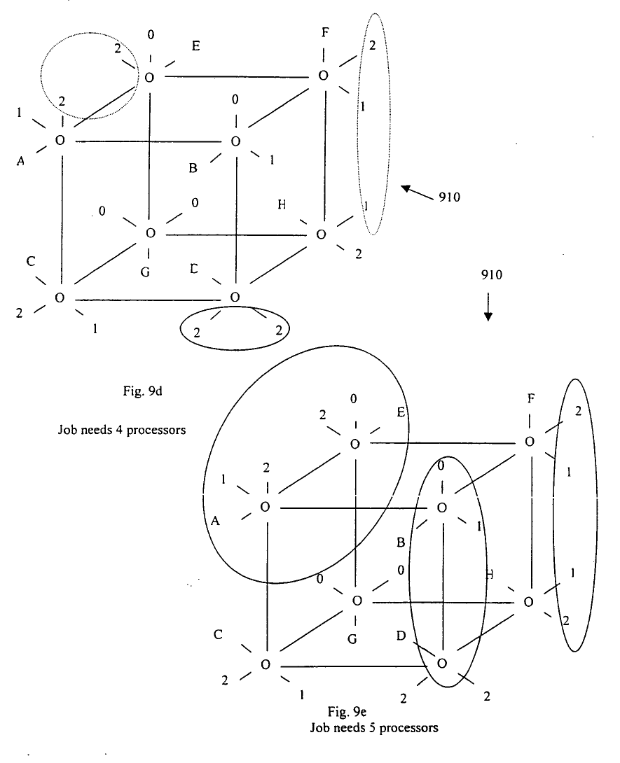

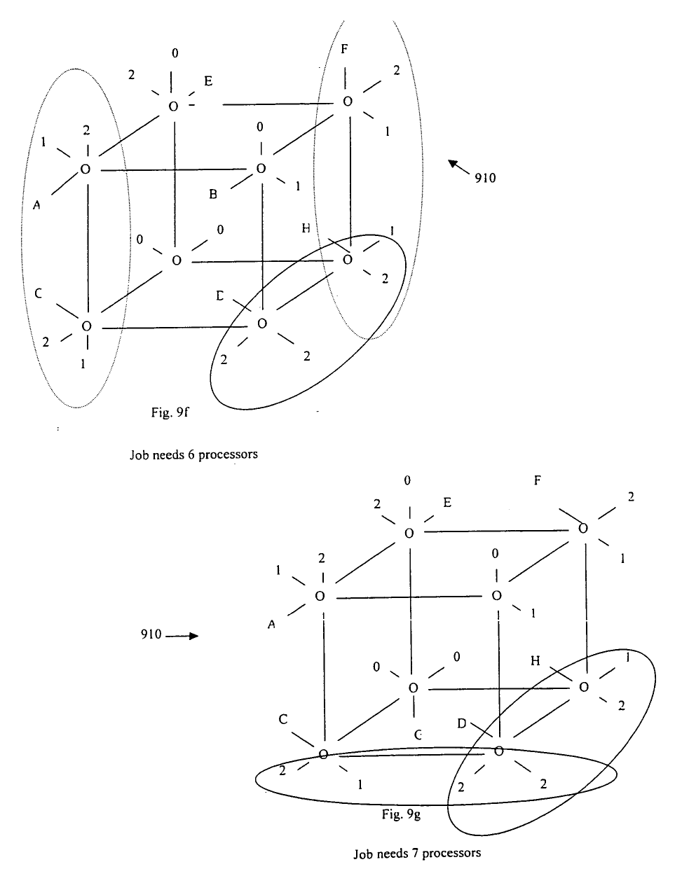

FIGS. 8a to 8c and 9a to 9g illustrate the selection and allocation of a job 104 to corresponding resources 130, depending on status of the resources 130, including the processors 12, 14 within each module 40. In this way, the status information signals Is by the topology monitoring unit 120 reflect the available or virtual topology as compared to the actual physical topology. FIG. 8a illustrates the actual or physical topology 800 of a non-uniform memory access system, similar to topology 8 shown in FIG. 1a. In particular, the topology 800 has eight node boards, each node board having two processors, indicated by the number “2”, and four interconnections, labelled by the letters A, B, C, D, respectively.

In FIG. 8a, the actual topology 800 shows that two processors are available on each node board, which would be the case if all of the processors are operating, and, are not executing other jobs. By contrast, FIGS. 8b and 8c are the available or virtual topology 810 corresponding to the physical topology 800 shown in FIG. 8a. The principle difference between the virtual topology 810 shown in FIGS. 8b, 8c and the actual topology 800 shown in FIG. 8a, is that the virtual topology 810 does not indicate that both processors are available at all of the node boards. Rather, as shown at interconnection A, one processor is available in one node board, and no processors available in the other node board. This is reflective of the fact that not all of the processors will be available to execute jobs all of the time. Similarly, FIGS. 8b and 8c illustrates that at interconnection B one processor is available at each node board, at interconnection C, no processors are available at one node board and both processors are available on the other node board, and at interconnection D both processors are available at one node board and one processor is available at the other node board. A similar representation of the available virtual topology will be used in FIGS. 9a to 9g as discussed below.

FIG. 8b illustrates the possible allocation of a job 104 requiring two processors 12, 14 to execute in FIG. 8b. The “best” group of node board 10 for executing the job 104 requiring two processors 12, 14, is shown by the solid circles around the node boards having two free processors, at interconnections C and D. This is the case because the processors 12, 14 on these node boards each have a radius of zero, because they are located on the same node board. The status information signals Is generated by the topology unit 120 would reflect the virtual topology 810 by indicating what resources 130, including processors 12, 14 are available. When the job scheduling unit 110 receives the job 104 requiring two processors to run, the external scheduler 114 may schedule the job 104 to the host 40 containing these two node boards 10.

Preferably, the external scheduler 114 or the topology daemon would also determine which processor 12, 14 are the “best” fit, based on predetermined criteria. Likely the node board at interconnection C would be preferred so as to maintain three free processors at interconnection D should a job requiring three CPUs be submitted while the present job is still being executed. Less preferred selections are shown by the dotted oval indicating the two node boards at interconnection B. These two node boards are less preferred, because the processors would need to communicate through interconnection B, having a radius of one, which, is less favourable than a radius of zero, as is the case with the node boards at C and D.

FIG. 8c shows a similar situation where a job indicating that it requires three CPUs is to be scheduled. The “best” allocation of resources 130 would likely occur by allocating the job to the three processors available at interconnection D. In this way, the maximum radius, or diameter between the processors would be 1, indicating that data at most would need to be communicated through the interconnection D. A less favourable allocation is shown by the dashed oval encompassing the processors at nodes A and C. This is less favourable because the maximum radius or diameter between the processors would be three, indicating a greater variable latency for execution.

In a similar manner, FIG. 9a illustrates the actual physical topology 900 of a 16 board topology, similar to topology 6 shown in FIG. 2a. Using the same symbolic representation as was used above with respect to FIGS. 8a to 8c, FIG. 9a illustrates the actual or physical topology 900 while FIGS. 9b to 9g will illustrate the virtual topology 910 reflecting that some of the processors are not available to execute additional jobs.

FIG. 9b illustrates the possible allocation of a job 104 requiring two processors 12, 14 to be executed. In this case, there are a large number of possibilities for executing the job 104. FIG. 9b shows with a solid round circle two free processors that can execute the job 104 on the same node board thereby having a radius of zero.

FIG. 9c illustrates with solid ovals, the possible allocation of a job 104 requiring three processors 12, 14, these node boards have a radius of one which is the minimum radius possible for a job 104 requiring three processors when the actual topology 900 processors on each node board 10. The processors at the node boards near connection D are shown in dashed lines, indicating that, while both processors on both node boards are available, this is not the preferred allocation because it would leave one available processor at one of the node boards. Rather, the preferred allocation would be to one of the other nodes A, C, F or H, where one of the processors is already allocated, so that the resources 130 could be used more efficiently.

FIG. 9d shows the possible allocation for a job 140 known to require four processors. As shown in FIG. 9d, the preferred allocation is the four processors near interconnection D, because their radius would be a maximum of 1. The dashed oval shows alternate potential allocation of processors, having a radius of two, and therefore being less favourable.

FIGS. 9e, 9f and 9g each illustrate groups of processors that are available to execute jobs requiring five CPUs, six CPUs or seven CPUs. In FIG. 9e, the oval encompassing the node boards adjacent interconnections A and E as well as the oval encompassing the node boards near interconnections B and D have a radius of two, and therefore would be preferred.

In FIG. 9f, the oval encompassing the node boards near interconnections D and H have a radius of two and therefore would be preferred for jobs requiring six processors 12, 14. In this embodiment, the dashed ovals encompassing interconnections A and B and F and H provide alternate processors to which the job 104 requiring six processors 12, 14 could be allocated. These alternate processors may be preferred if additional memory is required, because the processors are spread across 4 node boards, thereby potentially having more memory available than the 3 node boards contained within the solid oval.

FIG. 9g contains two solid ovals each containing seven processors with a radius of two. Accordingly, the processors 12, 14 contained in either one of the ovals illustrated in the FIG. 9g could be equally acceptable to execute a job 104 requiring seven processors 12, 14 assuming the only predetermined criteria for allocating jobs 104 is minimum radius. If other predetermined criteria are considered, one of these two groups could be preferred.

FIGS. 8 and 9 illustrate how knowledge of the available processors to create the virtual topologies 810 and 910 can assist in efficiently allocating the jobs 104 to the resources 130. It is understood that the topology monitoring unit 120 will provide information signals Is reflecting the virtual topology of 810 and 910 of the plurality of processors. With this information, the external scheduler 114 can then allocate the jobs 104 to the group of processors 12, 14 available in all of the host or modules 40 based on the information signals I_{S} received from the topology unit 120. In the case where topology daemons 121 are located on each host or module 40, the external scheduler 114 will receive module information signals I_{S} from each topology daemon 121 indicating the status of the resources 130 in the hosts 40 and reflecting the virtual topology, such as virtual topologies 810, 910, discussed above with respect to FIGS. 8b, 8c and 9b to 9g.

The status information signals Is could simply indicate the number of available processors 12, 14 at each radius. The external scheduler 114 then sort the hosts 40 based on the predetermined criteria. For instance, the external scheduler 114 could sort the hosts based on which one has the greatest number of processors available at the radius the job 104 requires. The job scheduler 110 then dispatches the job 104 to the host which best satisfies the predetermined requirements. Once the job 104 has been dispatched and allocated, the topology monitoring unit 120 will update the information status signals I_{S} to reflect that the processors 12, 14 to which the job 104 has been allocated are not available.

Accordingly, the topology monitoring unit 120 will provide information signals Is which would permit the jobs scheduling unit 110 to then schedule the jobs 104 to the processors 12, 14. In the case where there are several possibilities, the external schedule 114 will sort the hosts based on the available topology, as reflected by the information status signals I_{S}. In other words, the same determination that was made for the virtual topologies 810, 910, illustrated above, for jobs 104 having specific processor or other requirements, would be made for all of the various virtual topologies in each of the modules 40 in order to best allocate the jobs 104 within the entire system 100.

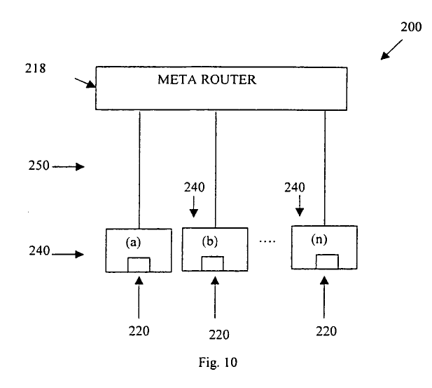

It is apparent that this has significant advantages to systems, such as system 100 shown in FIG. 6 with two hosts 40a, 40b. However, the advantages become even greater as the number of hosts increase. For instance, FIG. 10 illustrates a system 200 having a META router 210 capable of routing data and jobs to a variety of hosts or modules 240, identified by letters a, b . . . n. The META router 210 can allocate the jobs and send data amongst the various hosts or modules 240 such that the system 200 can be considered a scalable multiprocessor system. The META router 210 can transfer the jobs in data through any type of network as shown generally by reference numeral 250. For instance, the network 250 can be an intranetwork, but could also have connections through the internet, providing the result that the META router 210 could route data and jobs to a large number of hosts or modules 240 located remotely from each other. The system 200 also comprises a topology monitoring unit, shown generally by the reference numeral 220. The topology monitoring unit 220 would then monitor the status of the processors in each of the hosts or modules 240 and provide information indicative of the status of the resources. In this way, jobs 104 can be routed through the system 200 to be executed by the most efficient group of processors located on one or more of the host or module 240. In addition, when calculating the radius and delays in the system, different radius calculations can be made to reflect the different time delays of the various interconnections. This is akin to the time delay created by the cray router 42 shown in FIG. 4 that would 20 to processors located within the same module.

It is understood that the term “jobs” as used herein generally refers to computer tasks that require various resources of a computer system to be processed. The resources a job may require include computational resources of the host system, memory retrieval/storage resources, output resources and the availability of specific processing capabilities, such as software licenses or network bandwidth.

It is also understood that the term “memory” as used herein is generally intended in a general, non-limiting sense. In particular, the term “memory” can indicate a distributed memory, a memory hierarchy, such as comprising banks of memories with different access times, or a set of memories of different types.

It is also understood that, while the present invention has been described in terms of a multiprocessor system having non-uniform memory access (NUMA), the present invention is not restricted to such memory architecture. Rather, the present invention can be modified to support other types of memory architecture, with the status information signals I_{S} containing corresponding information.

It is understood that the terms “resources 130”, “node board 10”, “groups of node boards 10” and “CPUset(s)” and processor sets have been used to define both requirements to execute a job 104 and the ability to execute the job 104. In general, resources 130 have been used to refer to any part of computer system, such as CPUs 12, 14, node boards 10, memory 18, as well as data or code that can be allocated to a job 104. The term “groups of node boards 10” has been generally used to refer to various possible arrangements or topologies of node boards 10, whether or not on the same host 40, and include processor sets, which is generally intended to refer to sets of CPUs 12, 14, generally on node boards 10, which have been created and allocated to a particular job 104.

It is further understood that the terms modules and hosts have been used interchangeably to refer to the physical configuration where the processors or groups of nodes are physically located. It is understood that the different actual physical configurations, and, different terms to describe the physical configurations, may be used as is known to a person skilled in the art. However, it is understood that the terms hosts and modules refer to clusters and processors, having non-uniform memory access architecture.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments that are functional, electrical or mechanical equivalents of the specific embodiments and features that have been described and illustrated herein.

1. In a computer system comprising a cluster of node boards, each node board having at least one central processor unit (CPU) and shared memory, said node boards being interconnected into groups of node boards providing access between the central processing units (CPUs) and shared memory on different node boards, a scheduling system to schedule a job to said node boards which have resources to execute the jobs, said batch scheduling system comprising:
a topology monitoring unit for monitoring a status of the CPUs and generating status information signals indicative of the status of each group of node boards;
a job scheduling unit for receiving said status information signals and said jobs, and, scheduling the job to one group of node boards on the basis of which group of node boards have the resources required to execute the job as indicated by the status information signals.

2. The scheduling system as defined in claim 1 wherein the status information signals indicate which CPUs in each group of node boards have available resources, and, the job scheduling unit schedules jobs to groups of node boards which have resources required to execute the job.

3. The scheduling system as defined in claim 1 wherein the status information signals for each group of node boards indicate a number of CPUs available to execute jobs for each radius; and
wherein the job scheduling unit allocates the jobs to the one group of node boards on the basis of which group of node boards have CPUs available to execute jobs of a radius required to execute the job.

4. The batch scheduling system as defined in claim 3 wherein said cluster of node boards are located on separate hosts; and
wherein the topology monitoring unit monitors the status of the CPUs in each host and generates status information signals regarding groups of node boards in each host.

5. The batch scheduling system as defined in claim 4 wherein the status information signals include, for each host, a number of CPUs which are available for each radius; and
wherein the scheduling unit maps the job to a selected host having a maximum number of CPUs available at a radius corresponding to the required radius for the job.

6. The batch scheduling system as defined in claim 5 further comprising, for each host, a job execution unit for receiving jobs which have been scheduled to the selected host by the job scheduling unit, and, allocating the jobs to the selected group of node boards; and
wherein the job execution unit communicates with the topology monitoring unit to allocate the jobs to the group of node boards which the topology monitoring unit has determined have the resources required to execute the job.

7. The batch scheduling system as defined in claim 1 wherein the scheduler comprises a standard scheduler for allocating jobs to the selected group of node boards and an external scheduler for receiving the status information signals from the topology monitoring unit and selecting the selected group of node boards based on the status of the information signals.

8. The batch scheduling system as defined in claim 3 wherein if the job scheduling unit cannot locate a group of node boards which have the resources required to execute the job, the job scheduling unit delays allocation of the job until the status information signals indicate the resources required to execute the job are available.

9. The batch scheduling system as defined in claim 3 wherein the access between the central processing units (CPUs) and shared memory on different node boards is non-uniform.

10. In a computer system comprising resources physically located in more than one module, said resources including a plurality of processors being interconnected by a number of interconnections in a physical topology providing non-uniform access to other resources of said computer system, a method of scheduling a job to said resources, said method comprising the steps of:
(a) periodically assessing a status of the resources and sending status information signals indicative of the status of the resources to a job scheduling unit;
(b) assessing, at the job scheduling unit, the resources required to execute a job;
(c) comparing, at the job scheduling unit, the resources required to execute the job and resources available based on the status information signals; and
(d) scheduling the job to the resources which are available to execute the job as based on the status information signals and the physical topology, and the resources required to execute the job.

11. The method as defined in claim 10 further comprising the sub-steps of:
(a)(i) periodically assessing the status of resources in each module and sending status information signals indicative of the status of the resources in each module to the job scheduling unit;
(c)(i) comparing the available resources in each module to the resources required to execute the job; and
(d)(i) scheduling the job to the module having the most resources available to execute the job.

12. The method as defined in claim 10 further comprising the sub-steps of:
(a)(i) for each module, periodically assessing the status of the resources by assessing the status of each processor in each module and sending to the job scheduling unit module status information for each module indicative of a number of available processors at each radius in the module;
(b)(i) assessing, at the job scheduling unit, the requirements necessary to execute the job by determining the number of processors of a required radius required to execute the job;
(c)(i) comparing the resources required to execute the job and the resources available by comparing the number of processors of the required radius to execute the job and the number of available processors of the required radius at each module based on the module information status signals; and
(d)(i) scheduling the job to the module which has a largest number of available processors at the required radius based on the module status information signals and the physical topology.

13. In a computer system comprising resources including a plurality of processors, said processors being interconnected by a number of interconnections in a physical topology providing non-uniform access to other resources of said computer system, a scheduling system to schedule jobs to said resources, said scheduling system comprising:
a topology monitoring unit for monitoring a status of the processors and generating status information signals indicative of the status of said processors;
a job scheduling unit for receiving said status information signals and said jobs, and, scheduling the jobs to groups of processors on the basis of the physical topology and the status information signals.

14. The scheduling system as defined in claim 13 wherein the job scheduling unit schedules the jobs based on predetermined criteria, said predetermined criteria including the expected delay to transfer information amongst the group of processors based on the physical topology and the status information signals.

15. The scheduling system as defined in claim 14 wherein the predetermined criteria include a radius of the group of processors to execute the job.

16. The scheduling system as defined in claim 15 wherein the predetermined criteria further include the number of connections in the physical topology within the group of processors, availability of memory associated with the group of processors and availability of other processors connected to the group of processors.

17. The scheduling system as defined in claim 13 wherein the plurality of processors are physically located in separate modules. Wherein the topology monitoring unit comprises topology daemons associated with each module for monitoring a status of the processors physically located in the associated module and generating module status information signals indicative of the status of the processors in the associated module, wherein the job scheduling unit receives the module status information signals from all of the topology daemons and allocates the jobs to a group of processors in one of the modules on the basis of the physical topology of the processors in the modules and the module status information signals from all of the modules.

18. The scheduling system as defined in claim 17 wherein the modules are interconnnected by a META router operating on a network;
wherein the jobs and the module status information signals are communicated through the META router and network.

19. The scheduling system as defined in claim 18 wherein the network comprises an Internet.

20. The scheduling system is defined in claim 17 wherein the module status information signals indicate a number of available processors for each radius; and wherein the job scheduling unit schedules the job to a module having available processor of a radius required to execute the job.

21. The scheduling system as defined in claim 20 wherein the scheduling unit schedules jobs to the module having a greatest number of available processors of a radius required to execute the job.
